(19) United States
(12) Patent Application Publication
(10) Pub. No.: US 2014/0162927 A1
(43) Pub. Date: Jun. 12, 2014

(54) Surface Cleaning and Coating Method and System

(71) Applicant: Mark Nolde, St. Augustine, FL (US)

(72) Inventor: Mark Nolde, St. Augustine, FL (US)

(21) Appl. No.: 13/711,889

(22) Filed: Dec. 12, 2012

(51) Int. Cl. C11D 3/00; C09D 1/00

(52) U.S. Cl. CPC C11D 3/0036; C09D 1/00
USPC 510/241; 427/429; 510/245; 510/400

(57) ABSTRACT

The cleaning formulation and method uses a polysilazane for superior cleaning and to create a protective coating with “easy clean” properties on numerous surface types, including metals, marine paints and gel-coat surfaces; cleaning and guarding them from the effects of all types of accretions, including two of the most pernicious—ice and diesel exhaust soot. The polysilazane is used with a cyclomethicone solvent, preferably pentacyclomethicone and/or hexacyclomethicone. The preferred method of application is by direct contact and application of the cleaning formulation to the treated surface via a microfiber cloth wrapped around a firm rubber blade or the like.

### CROSS-REFERENCE TO RELATED APPLICATIONS

This non-provisional application is based on and claims priority through my non-provisional application titled “Surface Coating System” (Ser. No. 61/576,564) filed Dec. 16, 2011. The benefit under 35 USC §119(e) of this United States provisional application is hereby claimed, and the aforementioned application is hereby incorporated herein by reference.

### BACKGROUND OF THE INVENTION

1. Field of the Invention

This invention pertains generally to formulations, methods and systems for cleaning, restoring and/or protecting/repelling surface grime, soot, ice or other accretions and soiling elements using polysilazane based coatings. More particularly, the invention pertains to formulations, systems and techniques for achieving the foregoing on surfaces such as metal surfaces, marine paint surfaces, and gel-coat surfaces using polysilazane and/or organopolysilazanes with pentacyclomethicone and/or hexacyclomethicone as a solvent.

2. Description of the Related Art

The cleaning and restoration of gel-coat and marine paint surfaces is typically a difficult, time consuming and expensive process. This is a particular problem in maritime applications, as diesel soot sticks to marine paints and/or stains other painted and coated vessel surfaces. It is very difficult to remove, generally requiring surface cleaning, preparation and repainting at great expense in order to restore and refresh surfaces, especially high gloss hull surfaces. However, diesel soot can also be a problem in areas as diverse as railway and automobile tunnels.

Likewise, the buildup of ice is a problem that seriously impacts numerous areas of modern life, including buildup on vehicles, vessels, and aircraft. It is a matter of particular concern in regard to aircraft control surfaces, and is especially dangerous and problematic in cold, rainy weather. This ice can severely affect an aircraft's handling and endanger craft, passengers and crew. Similarly, the buildup of ice on marine vessels is also an issue for the same reasons. While alcohol bleed systems, or heating systems based on exhaust heat or electrical power exist, there is no passive method of deterring ice buildup known to the inventor.

Polysilazanes are polymers based on chains of alternating silicon and nitrogen atoms, with each silicon atom bound to two separate nitrogen atoms and each nitrogen atom to two silicon atoms. Physically, they tend to form colorless or pale yellow liquids or solids with an average molecular weight ranging from a few thousand to approximately 100,000 g/mol with density normally lying around 1 g/cm³. Aggregation and the viscosity are both dependent on the molecular mass and the molecular macrostructure.

However, though polysilazanes have found some applications, relatively few marketable polysilazane products have been developed. Development has been hampered both by changing commercial availability and expense, though one area where Polysilazanes have shown promise is in coatings taking advantage of their reaction with moisture and polar surfaces. For example, numerous metals, glass, ceramics and/or plastics with surface OH groups are easily wetted by polysilazanes. Reaction of Si—N with OH leads to the formation of Si—O-metal bonds generating good adhesion of the coating to the substrate, and the “free” surface of the coating can react with humidity to create a siloxane-like structure with excellent “easy to clean” properties, making it suitable for use as an anti-graffiti coating.

In contrast to Polysilazanes, both in terms of numbers of applications and field of applications. Cyclomethicones have found wide usage in numerous products such as cosmetics and related personal care items. Thus, they are typically found in products such as hair coloring agents, suntan and sunscreen lotions, make-up products, deodorants, facial moisturizers, hair conditioners and the like for human use and application. Cyclomethicones are volatile polydimethylcyclosiloxanes that are clear, tasteless, odorless, non-greasy and non-stinging. Due to their volatility, low surface tensions (which given them a high spreadability), and non-greasy feel, Cyclomethicones are used as base fluids, carrying agents and wetting agents in a wide range of such personal care products.

Cyclomethicone fluids are not only “safe”, but “environmentally friendly,” making them exempt from Federal Volatile Organic Compound (“VOC”) regulations, California VOC Regulations, and regulation as Over the Counter (“OTC”) products and/or medications. Moreover, they are compatible with most substrates, including metals and plastics. However, though they have been used in a wide variety of personal care applications such as body sprays, antiperspirants, skin creams, skin lotions, suntan lotions, bath oils, hair care products, etc., they have never—to the best of the inventor's personal knowledge and belief—been used with or as a solvent with and for Polysilazane, nor used with Polysilazane in forming coatings and cleaners, nor used with Polysilazane to form both a cleaning agent and a lasting protective coating for metal surfaces, marine paints and/or gel coatings that acts to repel further accretions, including grime, ice, soot, and soiling of any type.

### SUMMARY OF THE INVENTION

I have discovered that a polysilazane can be used for superior cleaning and to create a protective coating with “easy clean” properties on numerous surface types, including metals, marine paints and gel-coat surfaces; cleaning and guarding them from the effects of all types of accretions, including two of the most pernicious—ice and diesel exhaust soot. I have also discovered that polysilazane can be advantageously used with a cyclomethicone solvent, preferably pentacyclomethicone and/or hexacyclomethicone. Likewise, I have discovered that in addition to the benefits derived from the polysilazane described above, numerous additional desirable characteristics and synergistic benefits are derived from this novel and nonobvious combination of polysilazane with a solvent normally used for and with cosmetic and personal care products, namely: (1) excellent coating flattening and wetting (also known as “leveling”) of and on the treated surface to form a uniform glossy film (which is not possible with most other solvents compatible with polysilazane due to their high surface tension); (2) relatively low flammability and flash point relative to boiling point when compared to the high flammability and flash point of other compatible hydrocarbon based solvents compatible with polysilazanes; (3) a very low volatile organic carbon rating (VOC), creating a very environmentally friendly product which, in most jurisdictions, is exempt from many regulations that would otherwise be applicable; and (4) the creation of a very bright and glossy coating that looks like it has been sprayed on even though the coating is applied by direct contact with the treated surface via brush, roller, cloth, etc., or (as I have found most productive) via a microfiber cloth wrapped around a firm rubber blade (or similar item/construct).

Direct application in this manner is also preferred and advantageous because spraying techniques such as are typical in the art require expensive tenting (to reclaim high VOC solvent) as well as masking, with the extra effort and work implied thereby and/or result in substantial waste of the liquid treatment as over-spray (which can contaminate the surrounding area and/or adjacent craft). This is a typical problem with existing “state-of-the-art” coatings, and might present a problem when working with volatiles of the type used in the invention. However, the hand application method avoids the need for tenting, avoids over-spray and cuts the cost of coating a vessel, vehicle or craft dramatically, while providing a finish far superior to that possible with existing products that are applied by a brush, roller or other hand application methods. Thus, in numerous ways, my invention has proved to be an advance over prior art techniques in this field.

### BRIEF DESCRIPTION OF THE DRAWINGS

FIG. 1 provides a schematic diagram representing polysilazane being combined with, and/or dissolved in, a cyclomethicone solvent, preferably pentacyclomethicone and/or hexacyclomethicone, to form the cleaning and restorative polysilazane based cleaning/coating solution of the invention.

FIG. 2 provides a schematic illustration of the said polysilazane based cleaning/coating solution of the invention being directly applied to a surface such as, by way of example, the surface of a vessel, vehicle, aircraft, railway tunnel, and/or automobile tunnel in accordance with the further teachings of the invention.

### DESCRIPTION

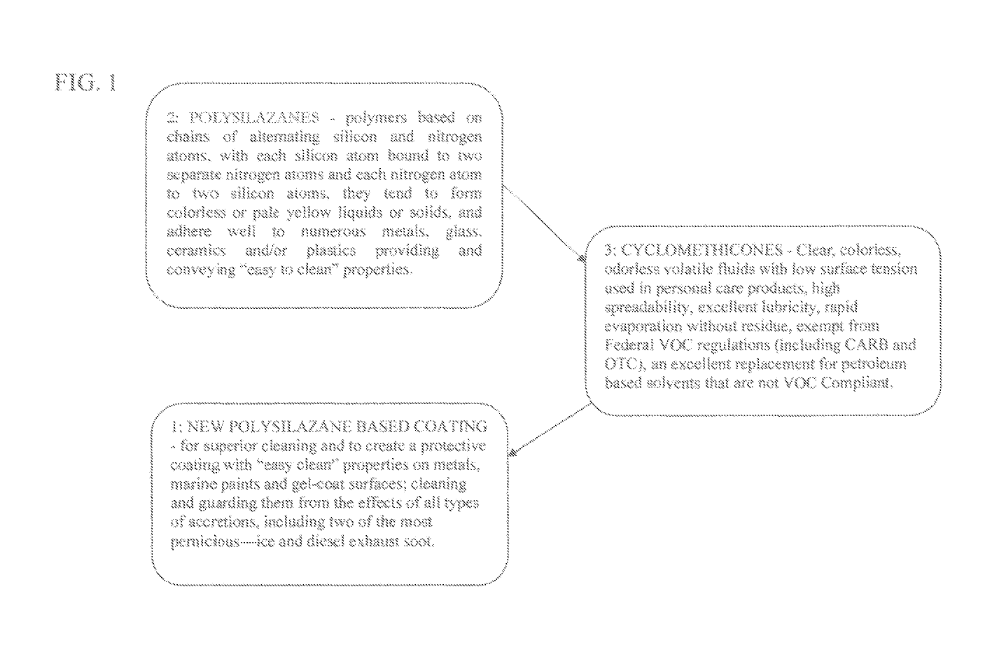

In accordance with FIG. 1, the cleaning, restorative and protective polysilazane based cleaning/coating solution l of the invention is formed from combining polysilazane 2 with (by dissolving it in) a cyclomethicone solvent 3, preferably pentacyclomethicone and/or hexacyclomethicone. The choice of these two as preferred for the purposes of the invention arises from several factors. First, the cyclic (ring) versions of these compounds are volatile, and useful for solvents whereas the straight-chain versions of similar molecular weight are non-volatile, and so of no use as solvents for this application. Second, Siloxane based solvents are less flammable than their carbon based counterparts like t-butyl acetate and of course qualify for lower VOC ratings (as they contain less carbon atoms. Third, cyclic siloxane solvents are generally available in three types: Penta (5 Si—O units); Hexa (6 Si—O)-units); and Tetra (4 Si—O-units). The tetra form is the most volatile, and hence flammable and of less interest in terms of the applications discussed. However, pentacyclomethicone and hexacyclomethicone are not only fast drying; they are also not classified as flammable for transport purposes. This makes them ideal, both from a functional as well as a practical commercial standpoint, for the purposes of the invention. Thus, and in accordance with the foregoing, I have generally found that a combination of approximately 30-80% organopolysilazane dissolved in 30-80% cyclomethicone solvent works best for the purposes of the invention, with most formulations falling in the 40% to 60% range. In addition, 0-10% of the combination may be formed of other additives known in the art to help provide UV protection, additional leveling, pigments, adhesion promoters, and so forth.

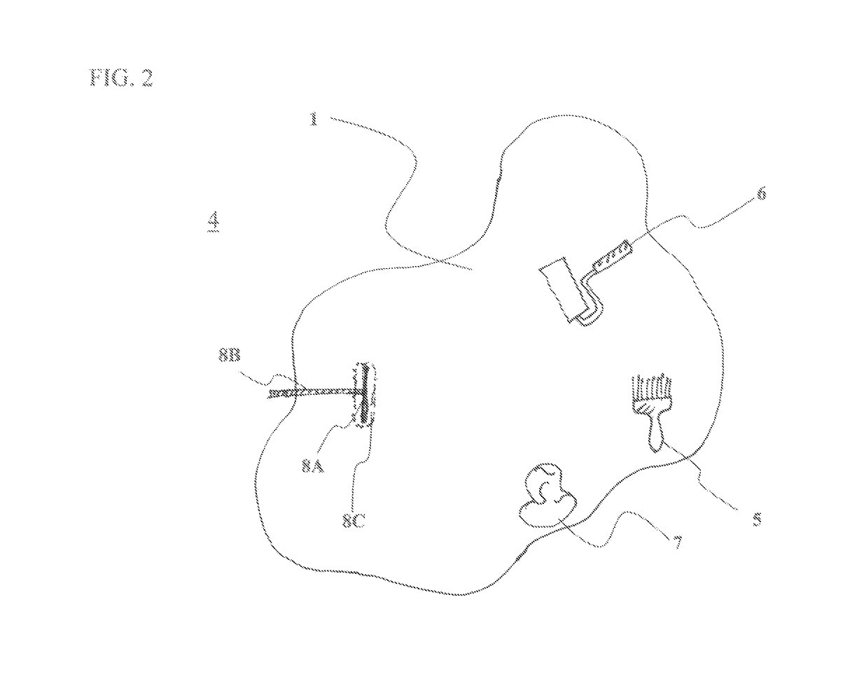

In accordance with FIG. 2, the said polysilazane based cleaning/coating solution 1 of the invention can easily be directly applied to an aircraft surface, vehicle surface, vessel surface, railway tunnel surface, automobile tunnel surface, or other suitable surface 4 in accordance with the further teachings of the invention via brush 5, roller 6, cloth 7, or (as I have found most productive) via a firm rubber blade 8A with handle 8B (or “squeegee” 8) with the blade 8A wrapped in a microfiber cloth 8C. Direct rubbing application helps to remove grime, stains and other surface discolorations, and the recommended firm rubber blade 8A wrapped in a microfiber cloth 8C is particularly useful for this purpose as the edge of the blade 8A helps in spreading and creating a thin film of cleaning/coating solution 1 on the treated surface, while the overlying microfiber cloth wrapping 8C helps retain cleaning/coating solution 1 for spreading and also provides a textured surface for loosening and removing grime and stains. The polysilazane 2 based cleaning solution/coating I provides a superior cleaning, removing and eliminating diesel exhaust soot and other stains, while its highly volatile cyclomethicone solvent 3 provides both easy spreadability and flattening to leave a uniform glossy film which dries quickly (as the highly volatile cyclomethicone solvent 3 evaporates completely in a short period). The result is a uniform and very bright and high gloss finish that looks like it has been sprayed onto the treated surface 4 and serves to repel ice, dirt, grime, stains, soot, and other accretions.

In view of the foregoing, it should be clear that numerous changes and variations can be made without exceeding the scope of the inventive concept outlined. Accordingly, it is to be understood that the embodiment(s) of the invention herein described is/are merely illustrative of the application of the principles of the invention. Reference herein to details of the illustrated embodiment(s) is not intended to limit the scope of the claims filed, which will themselves recite those features regarded as essential to the invention.

I claim:

1. A surface cleaning and coating method and system, comprising:
(a) combining polysilazane with a cyclomethicone solvent to form a surface cleaning and coating formulation;
(b) applying the formulation to a surface to be cleaned or coated.

2. The surface cleaning and coating method and system of claim 1, wherein the cyclomethicone solvent includes pentacyclomethicone.

3. The surface cleaning and coating method and system of claim 1, wherein the cyclomethicone solvent includes hexacyclomethicone.

4. The surface cleaning and coating method and system of claim 1, wherein approximately 40-60% of said formulation comprises organopolysilazane and approximately 40-60% of said formulation comprises cyclomethicone solvent.

5. The surface cleaning and coating method and system of claim 2, wherein approximately 40-60% of said formulation comprises organopolysilazane and approximately 40-60% of said formulation comprises cyclomethicone solvent.

6. The surface cleaning and coating method and system of claim 3, wherein approximately 40-60% of said formulation comprises organopolysilazane and approximately 40-60% of said formulation comprises cyclomethicone solvent.

7. The surface cleaning and coating method and system of claim 4, wherein approximately 10% of said formulation further comprises additional additives, including at least one of UV protection additives, leveling additives, and adhesion promoting additives.

8. The surface cleaning and coating method and system of claim 5, wherein approximately 10% of said formulation further comprises additional additives, including at least one of UV protection additives, leveling additives, and adhesion promoting additives.

9. The surface cleaning and coating method and system of claim 6, wherein approximately 10% of said formulation further comprises additional additives, including at least one of UV protection additives, leveling additives, and adhesion promoting additives.

10. The surface cleaning and coating method and system of claim 1, wherein said formulation is applied using a bladed member wrapped in a microfiber cloth.

11. The surface cleaning and coating method and system of claim 2, wherein said formulation is applied using a bladed member wrapped in a microfiber cloth.

12. The surface cleaning and coating method and system of claim 3, wherein said formulation is applied using a bladed member wrapped in a microfiber cloth.

13. The surface cleaning and coating method and system of claim 4, wherein said formulation is applied using a bladed member wrapped in a microfiber cloth.

14. The surface cleaning and coating method and system of claim 5, wherein said formulation is applied using a bladed member wrapped in a microfiber cloth.

15. The surface cleaning and coating method and system of claim 6, wherein said formulation is applied using a bladed member wrapped in a microfiber cloth.

16. The surface cleaning and coating method and system of claim 7, wherein said formulation is applied using a bladed member wrapped in a microfiber cloth.

17. The surface cleaning and coating method and system of claim 8, wherein said formulation is applied using a bladed member wrapped in a microfiber cloth.

18. The surface cleaning and coating method and system of claim 9, wherein said formulation is applied using a bladed member wrapped in a microfiber cloth.

19. The surface cleaning and coating method and system of claim 2, wherein said formulation is applied to one of a metal surface, a marine paint surface, and a gel-coat surface.

20. The surface cleaning and coating method and system of claim 3, wherein said formulation is applied to one of a metal surface, a marine paint surface, and a gel-coat surface.
